(19) United States
(12) Patent Application Publication
(10) Pub. No.: US 2026/0326322 A1
(43) Pub. Date: Oct. 22, 2026

(54) Hair Trimmer Capable of Cooling Blade

(71) Applicant: Ningbo Chuangxiang Electrical Appliance Co., Ltd., Ningbo, Zhejiang (CN)

(72) Inventor: Lifeng Fan, Ningbo, Zhejiang (CN)

(21) Appl. No.: 18/871,506

(22) PCT Filed: Nov. 21, 2023
(86) PCT No.: PCT/CN2023/132844

§ 371 Date: Dec. 4, 2024

(30) Foreign Application Priority Data
Mar. 30, 2023 (CN) 202320665709.8

(51) Int. Cl. B26B 19/38; B26B 19/04; B26B 19/28; F25B 21/02

(52) U.S. Cl. CPC B26B 19/28; B26B 19/02; B26B 19/38; B26B 19/3853; B26B 19/44; F25B 2321/0251

(57) ABSTRACT

This disclosure provides a hair trimmer capable of cooling the blade, comprising a body and blade that are thermally conductive to each other. The body contains a heat dissipation channel connected to the outside, and a fan blade is installed inside the body to expel heat from the heat dissipation channel to the outside. In this hair trimmer capable of cooling the blade, the blade transfers heat to the body, and under the action of the fan blade, the heat from the body is expelled to the outside through convection and conduction via the heat dissipation channel. This effectively reduces the temperature of the blade, ensures trimming efficiency, reduces the risk of skin burns, enhances safety, and improves user experience.

### TECHNICAL FIELD

This disclosure relates to the field of hair trimmer technology, specifically to a hair trimmer capable of cooling the blade.

### BACKGROUND TECHNOLOGY

Hair trimmers are common personal care products used for trimming hair. Hair trimmers typically include a drive motor and a blade, with the drive motor powering the blade to achieve hair trimming. However, during hair trimming, the blade may sometimes become hot due to prolonged reciprocating motion. Since the blade typically comes into contact with sensitive and thin skin, the perception of blade heat can be quite sensitive, thus affecting user experience.

### DISCLOSURE CONTENT

To solve at least one aspect of the above problem, this disclosure provides a hair trimmer capable of cooling the blade, comprising a body and a blade that are thermally conductive to each other, wherein the body contains a heat dissipation channel connected to the outside, and a fan blade is installed inside the body to expel heat from the heat dissipation channel to the outside.

Optionally, a dual-head motor is installed inside the body, the dual-head motor has a first output shaft and a second output shaft, the first output shaft is connected to the blade for power transmission, and the second output shaft is connected to the fan blade.

Optionally, it further includes a semiconductor cooling chip installed between the blade and the body, where the cooling surface of the semiconductor cooling chip is in contact with the blade.

Optionally, the fan blade is a centrifugal fan blade.

Optionally, the material of the body is metal.

Optionally, an insulation sleeve is fitted over the outer wall of the body.

Optionally, it further includes an inner lining shell for installing the dual-head motor and the fan blade, where the heat dissipation channel is formed between the body and the inner lining shell, the heat dissipation channel includes interconnected air intake channel and air outlet channel, and the air intake channel and the air outlet channel are located on the front and rear sides of the fan blade respectively.

Optionally, the air outlet channel includes an upper channel and a lower channel, both the upper channel and the lower channel are connected to the outside.

Optionally, the body is provided with multiple air inlets connected to the air intake channel.

Optionally, the air inlets are located on the front side of the fan blade.

Compared to the existing technology, in this hair trimmer capable of cooling the blade, the blade transfers heat to the body, and under the action of the fan blade, the heat from the body is expelled to the outside through convection and conduction via the heat dissipation channel. This effectively reduces the temperature of the blade, ensures trimming efficiency, reduces the risk of skin burns, enhances safety, and improves user experience.

### BRIEF DESCRIPTION OF FIGURES

FIG. 1 is a structural diagram of the hair trimmer capable of cooling the blade in this disclosure's embodiment;

FIG. 2 is a sectional view of the hair trimmer capable of cooling the blade in this disclosure's embodiment;

FIG. 3 is an enlarged view of part A in FIG. 2.

### REFERENCE NUMERALS

1—body; 11—air inlet; 2—blade; 3—heat dissipation channel; 31—air intake channel; 32—air outlet channel; 321—upper channel; 322—lower channel; 4—fan blade; 5—dual-head motor; 51—first output shaft; 52—second output shaft; 6—semiconductor cooling chip; 7—insulation sleeve; 8—inner lining shell.

### DETAILED DESCRIPTION OF EMBODIMENTS

To make the above objectives, features, and advantages of this disclosure more apparent and easier to understand, the specific embodiments of this disclosure will be described in detail with reference to the accompanying drawings.

In the description of this disclosure, it should be understood that terms such as “up” and “down” indicate orientations or positional relationships based on the normal use orientation or position of the product.

The terms “first” and “second” are used for descriptive purposes only and should not be understood as indicating or implying relative importance or implicitly indicating the number of technical features referred to. Thus, features defined as “first” and “second” may explicitly or implicitly include at least one such feature. The accompanying drawings of the embodiments in this disclosure have a coordinate system YZ, where the positive direction of the Y-axis represents the front, the negative direction of the Y-axis represents the rear, the positive direction of the Z-axis represents the top, and the negative direction of the Z-axis represents the bottom.

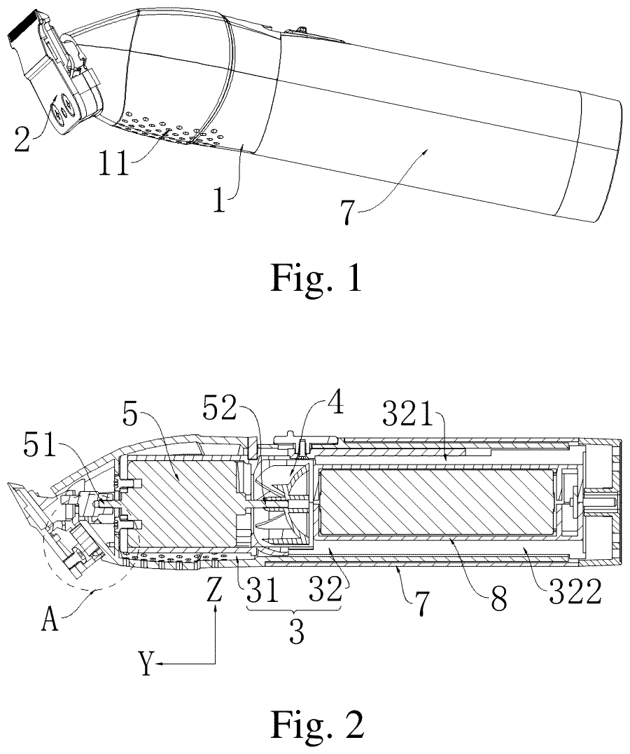

This disclosure's embodiments provide a hair trimmer capable of cooling the blade. As shown in FIGS. 1 and 2, it includes a body 1 and a blade 2 that are thermally conductive to each other, wherein the body 1 contains a heat dissipation channel 3 connected to the outside, and a fan blade 4 is installed inside the body 1 to expel heat from the heat dissipation channel 3 to the outside.

The blade 2 is the heat-generating element, and the body 1 is made of a thermally conductive material with good heat dissipation properties. The blade 2 is thermally connected to the body 1, allowing heat from the blade 2 to be conducted to the body 1. The drive motor inside the body 1 is connected to the blade 2 via an eccentric wheel, enabling the blade 2 to move reciprocally. The fan blade 4 is preferably driven by a motor.

In this embodiment of the hair trimmer capable of cooling the blade, the blade 2 transfers heat to the body 1, and under the action of the fan blade 4, the heat from the body 1 is expelled to the outside through convection and conduction via the heat dissipation channel 3. This ultimately effectively reduces the temperature of the blade 2, ensures trimming efficiency, reduces the risk of skin burns, enhances safety, and improves user experience.

Optionally, as shown in FIGS. 1 and 2, a dual-head motor 5 is installed inside the body 1. The dual-head motor 5 has a first output shaft 51 and a second output shaft 52, where the first output shaft 51 is connected to the blade 2 for power transmission, and the second output shaft 52 is connected to the fan blade 4.

The dual-head motor 5 can simultaneously drive the blade 2 and the fan blade 4, greatly saving installation space. When the dual-head motor 5 is working, the first output shaft 51 can drive the blade 2 to move reciprocally, achieving hair trimming, while the second output shaft 52 can drive the fan blade 4 to rotate synchronously, generating airflow to remove heat while trimming hair, thus cooling the blade 2.

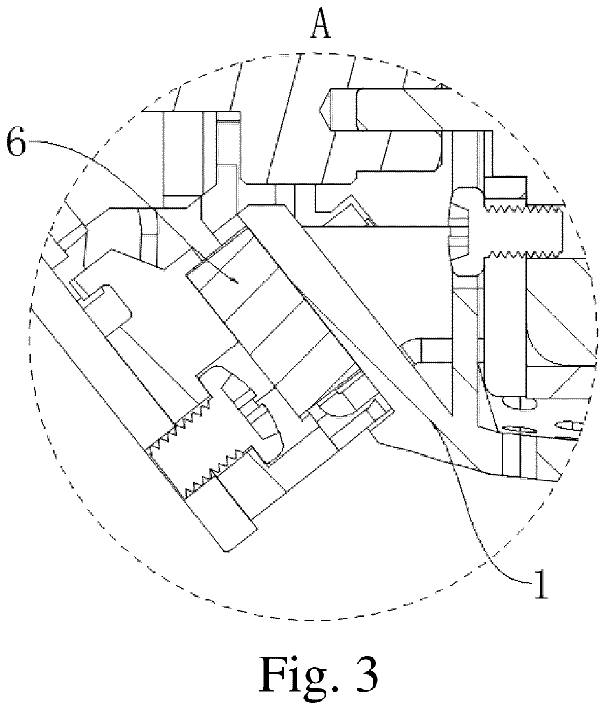

Optionally, as shown in FIGS. 1, 2, and 3, it also includes a semiconductor cooling chip 6 installed between the blade 2 and the body 1, where the cooling surface of the semiconductor cooling chip 6 is in contact with the blade 2.

The semiconductor cooling chip 6 is an electronic cooling technology that uses the thermoelectric effect of semiconductor materials to achieve cooling. When current passes through the junction of two different materials, they produce a temperature difference, with one side becoming cold the cooling surface and the other side becoming hot the heating surface. Semiconductor cooling chips 6 have advantages such as small size, light weight, no noise, high efficiency, energy-saving, and environmental friendliness. In this embodiment, the cooling surface of the semiconductor cooling chip 6 cools the blade 2, while the heat from the other side of the cooling chip (i.e., heating surface) is conducted to the body 1. Finally, under the action of the fan blade 4, the heat from the body 1 is expelled to the outside through convection and conduction via the heat dissipation channel 3.

Optionally, as shown in FIGS. 1 and 2, the fan blade 4 is a centrifugal fan blade 4. A centrifugal fan blade 4 is a type of blade that can produce high-pressure, low-flow air. The centrifugal fan blade 4 uses centrifugal force to move air from the center outwards, then changes the direction of the air, directing it into the air outlet channel 32 of the heat dissipation channel 3. In this embodiment, the centrifugal fan blade 4 draws air to expel heat from the body 1.

Optionally, the material of the body 1 is metal, which can specifically be chosen as copper or aluminum. Copper is a commonly used heat-conductive material with excellent thermal conductivity and good mechanical strength. Aluminum is another commonly used heat-conductive material with high thermal conductivity and relatively light weight. In addition, the material of the body 1 can also be graphite, which is a non-metallic heat-conductive material with good thermal conductivity and corrosion resistance, often used in high-temperature furnace components for heat conduction.

Optionally, as shown in FIGS. 1 and 2, an insulation sleeve 7 is fitted over the outer wall of the body 1. The insulation sleeve 7 is generally made of heat-insulating rubber material, which, when fitted over the metal body 1, can prevent the body 1 from burning the user and provide a better grip feel. The insulation sleeve 7 is placed on the part of the body 1 where the hand grips.

Optionally, as shown in FIGS. 1 and 2, it also includes an inner lining shell 8 for installing the dual-head motor 5 and the fan blade 4. The heat dissipation channel 3 is formed between the body 1 and the inner lining shell 8. The heat dissipation channel 3 includes interconnected air intake channel 31 and air outlet channel 32, and the air intake channel 31 and the air outlet channel 32 are located on the front and rear sides of the fan blade 4 respectively.

The dual-head motor 5 drives the fan blade 4 to rotate, generating wind power that draws in outside air through the air intake channel 31. After carrying away the heat, the air is expelled through the air outlet channel 32, thus cooling the blade 2 and improving comfort and safety during use. The inner lining shell 8 also provides heat insulation, protecting the motor and other key components, thereby extending the product's lifespan.

Optionally, as shown in FIG. 1 and FIG. 2, the air outlet channel 32 includes an upper channel 321 and a lower channel 322, both of which are connected to the outside. When the fan blade 4 starts working, outside air enters the air intake channel 31 and, under the action of the fan blade 4, flows towards the upper channel 321 and lower channel 322 respectively, then exits to the outside. This results in fast air circulation and high heat exchange efficiency.

Optionally, as shown in FIG. 1 and FIG. 2, the body 1 has multiple air inlets 11 connected to the air intake channel 31. These multiple air inlets 11 are spaced out on the body 1, ensuring sufficient air intake without affecting the overall appearance.

Optionally, as shown in FIG. 1 and FIG. 2, the air inlets 11 are located on the front side of the fan blade 4. With the air inlets 11 on the front side of the fan blade 4 and the air outlet at the tail of the body 1, the airflow enters from the front end of the body 1 and exits towards the tail end, reducing mutual interference between the airflow of the air inlets 11 and the air outlet, thus ensuring effective heat exchange.

Although the disclosure has been described as above, the scope of protection of this disclosure is not limited to this. Those skilled in the art can make various changes and modifications without departing from the spirit and scope of this disclosure, and these changes and modifications will all fall within the scope of protection of this disclosure.

1. A hair trimmer capable of cooling blade, characterized by comprising a body (1) and a blade (2) that are thermally conductive to each other, wherein the body (1) contains a heat dissipation channel (3) connected to the outside, and a fan blade (4) is installed inside the body (1) to expel heat from the heat dissipation channel (3) to the outside.

2. The hair trimmer capable of cooling the blade according to claim 1, characterized in that a dual-head motor (5) is installed inside the body (1), the dual-head motor (5) has a first output shaft (51) and a second output shaft (52), the first output shaft (51) is connected to the blade (2) for power transmission, and the second output shaft (52) is connected to the fan blade (4).

3. The hair trimmer capable of cooling blade according to claim 1, characterized by further comprising a semiconductor cooling chip (6) installed between the blade (2) and the body (1), wherein the cooling surface of the semiconductor cooling chip (6) is in contact with the blade (2).

4. The hair trimmer capable of cooling blade according to claim 1, characterized in that the fan blade (4) is a centrifugal fan blade (4).

5. The hair trimmer capable of cooling blade according to claim 1, characterized in that the material of the body (1) is metal.

6. The hair trimmer capable of cooling blade according to claim 1, characterized in that an insulation sleeve (7) is fitted over the outer wall of the body (1).

7. The hair trimmer capable of cooling blade according to claim 2, characterized by further comprising an inner lining shell (8) for installing the dual-head motor (5) and the fan blade (4), wherein the heat dissipation channel (3) is formed between the body (1) and the inner lining shell (8), the heat dissipation channel (3) includes interconnected air intake channel (31) and air outlet channel (32), and the air intake channel (31) and the air outlet channel (32) are located on the front and rear sides of the fan blade (4) respectively.

8. The hair trimmer capable of cooling blade according to claim 7, characterized in that the air outlet channel (32) includes an upper channel (321) and a lower channel (322), both the upper channel (321) and the lower channel (322) are connected to the outside.

9. The hair trimmer capable of cooling blade according to claim 7, characterized in that the body (1) is provided with multiple air inlets (11) connected to the air intake channel (31).

10. The hair trimmer capable of cooling blade according to claim 9, characterized in that the air inlets (11) are located on the front side of the fan blade (4).
